(19) United States
(12) Patent Application Publication
(10) Pub. No.: US 2006/0026514 A1
(43) Pub. Date: Feb. 2, 2006

(54) Electronic document editing program and sales method of the same

(76) Inventor: Akira Iwakiri, Kawasaki-shi (JP)

Correspondence Address: REED SMITH LLP, 3110 FAIRVIEW PARK DRIVE, SUITE 1400, FALLS CHURCH, VA, 22042, US

(21) Appl. No.: 11/183,915

(22) Filed: Jul. 19, 2005

(30) Foreign Application Priority Data
Jul. 20, 2004 (JP) 2004-237798

(51) Int. Cl. G06F 17/24; G06F 17/21

(52) U.S. Cl. 715/530; 715/513; 715/531

(57) ABSTRACT

The object of the present invention is to provide an electronic document editing program, which edits a plurality of electronic documents, of which a specific expression of text information and a specific part of image information are associated with each other by means of a common symbol, thereby editing the electronic document into a comprehensive form on a computer screen continuously. Another object of the present invention is to provide a sales method of the electronic document editing program. An electronic document editing program reads a symbol among image information, associates the read symbol with a common symbol among text information, highlights the associated symbol of image information when any one of the symbols among the text information is designated, stores the edited electronic document, and automatically starts editing of the next non-edited electronic document.

### TECHNICAL FIELD OF THE INVENTION

The present invention relates to an electronic document editing program, which edits an electronic document having text information and image information complementary to each other into a comprehensive form on a computer screen and also relates to a sales method of the program.

### DESCRIPTION OF THE RELATED ART

For example, in a case where a technical document describing technical contents with figures or pictures is made in a form of an electronic document, description sentences are mostly made as text information, and figures or pictures are mostly made as image information, respectively. On a computer screen which is divided into two areas, when the description sentences are displayed at one area and the figures or the pictures are displayed at another area, a user can read the description sentences referring to the figures or the pictures at the same time.

In a case where the figures or the pictures are complicated, in order to identify which part of the figures or which part of the pictures corresponds to each part of the description sentences and in order to easily find out a corresponding part from among the figures or the pictures, a common symbol is assigned to the part of the description sentences and to the corresponding part of the figures or the pictures. Thus the specific part of the description sentences and the corresponding part of the figures or the pictures are associated with each other, so that a user can easily understand the described contents.

However, in a case where the figures or the pictures are too complicated or too many symbols are mentioned in the figures or the pictures, it is difficult for a user to find out the corresponding symbol from among the figures and the pictures while reading the description sentences on the screen of a computer. Consequently, even though common symbols are assigned both in the description sentences and the figures or the pictures, the symbols can not achieve the expected function to have the description sentences associate with the figures or the pictures.

An electronic patent document is a good example. For instance, patent information published on the Patent Office Home Page is indicated as specification that is text information and as figures that are image information on a computer screen at the same time, so that a user reads the specification referring to the figures at the same time. However, in a figure which illustrates a complicated structure such as a mechanical system, there are indicated many reference symbols in the figure. It is difficult to find out a reference symbol mentioned in the specification from among many reference symbols of the figure. Furthermore, when there are many figures, it is much more difficult to find out a corresponding reference symbol from among the figures, because it is very difficult for the user to identify to which figure the corresponding reference symbol is assigned.

In Japanese Patent Application Laid-Open No. 2003-186870, a program to display a corresponding figure by clicking a mouse on a drawing number mentioned in sentence data (line 34 of column 24˜line 9 of column 25) is disclosed. Further, it is disclosed that by clicking the mouse on a character string having a symbol in the sentence data, a corresponding symbol of a corresponding figure is displayed at a center of the window (lines 47 to 48 of column 29), or the corresponding symbol is highlighted on the screen (lines 44 to 46 of column 29).

However, in the prior art recited therein, a character string having a symbol is recognized from text information (lines 32 to 41 of column 13) and the symbol is associated with a corresponding symbol in image information. It takes a long time to recognize the character string. Furthermore, in order to edit a plurality of documents, the same operation must be repeated several times. As a result, it is significantly difficult to edit a plurality of electronic documents in a short time.

### SUMMARY OF THE INVENTION

[Problems to be Solved by the Invention]

Accordingly, the object of the present invention is to provide an electronic document editing program, which edits a plurality of electronic documents having text information and image information both associated with each other into a comprehensive form on a computer screen, wherein a specific expression of the text information and a specific part of the image information correspond to each other by means of a common symbol in the plurality of electronic documents. Another object of the present invention is to provide a sales method of the electronic document editing program.

[Means for Solving the Problems]

The present invention provides an electronic document editing program for editing an electronic document that includes text information having a plurality of specific expressions and image information having a plurality of specific parts, and having the specific expressions of the text information and the specific parts of the image information associate with each other through common symbols, the electronic document editing program comprising: a symbol reading means for reading symbols that exist in the image information and the location information thereof; an associating means for associating a read result by the symbol reading means with the symbol that exists in the text information if a common symbol is allocated to both of them; and a highlighting display means for highlighting a corresponding symbol in the image information on a computer screen based on results of the associating means when any one of the symbols in the text information is designated.

Furthermore, the electronic document editing program sequentially extracts a plurality of electronic documents to be edited, and upon receiving an order to start the editing operation with a previously designated output field for each electronic document to be edited, edits one of the plurality of extracted electronic documents by the symbol reading means, the associating means, and the highlighting display means, stores the edited electronic document in the designated output field, and starts editing continuously a non-edited electronic document, if any, thereby enabling a plurality of electronic documents to be edited continuously.

Moreover, the present invention further comprises a manual associating means for correcting an incomplete read results by the symbol reading means with a manual operation, and for reflecting the corrected result onto the associating means.

Moreover, the present invention provides a sales method of said editing program, wherein a sales contract of the editing program and a delivery of the same are performed on a computer screen.

Furthermore, besides the sale of the editing program, the present invention provides an editing service for editing an electronic document designated by a client using the editing program.

The present invention further provides a sale of an edited electronic document using the editing program on the computer screen in addition to the sale of the editing program.

[Effects of the Invention]

According to an editing program of the present invention, when any one of symbols among text information is designated, a corresponding symbol among image information is caused to be highlighted. Consequently, even when a large number of symbols are included in the image information or a large number of figures or pictures of image information exist, the trouble of searching the symbol manually on the screen may be avoided, allowing a user to concentrate to understand the described contents. Furthermore, in a step of the editing operation, only a symbol among the image information is read and the read symbol is associated with a symbol among the text information. It is unnecessary to recognize a character string among the text information as disclosed in the prior art, thereby the editing operation may be performed in a relatively short time.

Moreover, when the editing operation of one electronic document finishes, and the edited electronic document is stored in a previously designated output field, an editing operation for the next electronic document automatically starts. This allows a plurality of electronic documents to be rapidly and continuously edited.

According to the editing program of the present invention, incomplete read results of symbols among image information are corrected by a manual operation with a manual associating means, thereby improving the accuracy of the editing.

In addition, according to a sales method of an editing program of the present invention, a sales contract and a delivery of the program are both performed on a computer screen, thereby enabling the sale to be rapid and economic.

Moreover, according to the sales method of the editing program of the present invention, an editing service of the electronic document using the editing program is added to the sale of the editing program itself, thereby it is expected to promote the sale of the editing program.

Further, according to the sales method of the editing program of the present invention, a sale of edited electronic documents is performed together with the sale of the editing program itself, thereby enabling to increase the added value of the electronic document.

[The Best Mode for Carrying out the Invention]

The best mode of embodiment of the present invention will be described, referring to figures.

FIG. 1 is a conceptual diagram showing a relationship between an electronic document 1 and an editing program 7. The electronic document 1 includes text information 2 and a plurality (three in FIG. 1) of image information 3a, 3b, and 3c that are complementary to each other. For example, assuming that the electronic document 1 is an electronic patent publication, the text information 2 corresponds to the specification and patent claims, and the image information 3a, 3b, and 3c corresponds to FIG. 1, FIG. 2, and FIG. 3 of the figures of the patent, respectively. As shown in FIG. 2, symbols 6 are assigned to a plurality of specific expressions 4 specified among the text information 2 of the electronic document 1 and to a plurality of specific parts 5 specified among the image information 3a, 3b, and 3c of the electronic document 1, respectively, thereby corresponding the specific expressions 4 and the specific parts 5 to each other. Whichever language may be used as a language of the text information 2. When the text information 2 is Japanese language, the parts of [OOO], [XXX], and [ΔΔΔ] indicated in FIG. 2 are Chinese characters, HIRAGANA, and KATAKANA. When the text information 2 is English language, they are alphabets and the like.

As shown in FIG. 1, the editing program 7 includes a symbol reading means 8, an associating means 9, and a highlighting display means 10.

As shown in FIG. 3, by an OCR recognition, the symbol reading means 8 reads a plurality of kinds of symbols 6 (A, B, C and the like) which exist in the image information 3a, 3b, and 3c, and location information of each symbol 6, as symbol information to make an image information symbol table 11.

The associating means 9 associates a symbol information output from the symbol reading means 8 with a symbol that exists in the text information 2 if a common symbol is allocated to both of them (FIG. 1).

The highlighting display means 10 forms an HTML file group 12 readable on a browser based on the associated result of the associating means 9. As shown in FIG. 4, when any one of symbols 6 (for example, B) of the text information 2 is designated, the highlighting display means 10 selects image information 3b having a symbol 6 of B from the image information symbol table 11, and displays it on a screen of a computer. In addition, FIG. 4 shows an image of a displayed electronic document edited by the editing program 7. The text information 2 and the image information 3 are displayed at the left and right sides of the computer screen, respectively, and a figure number list 13 is displayed at the right side of the computer screen. As shown in FIG. 5, through a display conversion, the image information 3 and the text information 2 can be displayed at upper and lower sides of the display screen, respectively. In FIG. 4 and FIG. 5, numeral reference 17 represents a mouse pointer.

When a symbol 6 of B exists in the plurality of image information 3b and 3c (for example, FIG. 2 and FIG. 3), the image information 3b (for example, FIG. 2) existing at the nearest position is displayed first. Simultaneously, a location where a symbol 6 of B in the image information 3b is described, is searched from the image information symbol table 11, and is displayed with a highlight on the screen of the computer by, for example, encircling the symbol 6 of B existing at the location. In order to view another image information 3c (for example, FIG. 3) in which the symbol of B exists, when a user clicks a corresponding figure number in the figure number list 13, the image information 3c is displayed on the converted screen, and the symbol 6 of B of the image information 3c is displayed with a highlight.

In addition, when a symbol 6 of the text information 2 is designated, the highlighting display means 10 may display with a highlight simultaneously the designated symbol 6 of the text information 2 and corresponding symbols 6 of the image information 3b and 3c.

A method for displaying a symbol 6 with a highlight is not limited to the encircling method, but any method is available, including a blinking method, a displaying method using a distinguishable color from the others, a conversion display method, an enlarging display method and the like, so far as the displayed symbol is visually distinguishable by the method.

As a method for designating any symbol 6 among the text information 2, it is acceptable to simply place a mouse pointer on the symbol or may be enough to place and click the mouse pointer on the symbol

An editing execution means 14 is installed in the editing program 7. As shown in FIG. 6, the editing execution means 14 designates and extracts one document or a plurality of documents from among the previously stored electronic documents 7, and starts a predetermined editing operation when a respective output field of each edited electronic document 7 is designated. Namely, a symbol reading means 8 reads and extracts symbol information from the image information of the electronic documents 7 to make an image information symbol table. Next, an associating means 9 associates the symbol information output from the symbol reading means 8 with a symbol 6 among the text information 2, if a common symbol is allocated to both of them. The edited electronic documents 7 are stored in a previously designated output field. If there still remains non-edited electronic document 7, an editing operation of the next electronic document 7 automatically starts.

The edited electronic documents 7 may be extracted from the output field and displayed on a screen of a computer, because the edited electronic documents 7 are stored in the designated output field.

Moreover, the symbol reading means 8 of the editing program 7 recognizes a symbol 6 among the image information 3a, 3b, and 3c, and location information of the symbol 6. However, it may not be always ascertained to obtain a high accuracy of edited result, since there are cases where the symbol 6 among the image information 3a, 3b, and 3c is not readable or erroneously read due to the ambiguousness of the symbol 6 itself or the misplacement of the symbol 6 as touching with a line of a figure.

Taking the above into consideration, the editing program 7 further includes an HTML file group reading means 15 and a manual associating means 16.

The HTML file group reading means 15 reads an HTML file group 12 made by the highlighting display means 10 and outputs it to the manual associating means 16. Regarding the symbol 6 among the image information 3a, 3b, and 3c that can not be read or erroneously read by the symbol reading means 8, with the manual associating means 16, an user reads the symbol on the screen of the computer with his or her own eyes so that the symbol 6 of the image information is correctly associated with the symbol 6 of the text information by manual operation and the corrected result is reflected to the associating means 9

Thus, the incompletely read result by the symbol detecting means 8 is corrected by a manual operation with the manual associating means 16, hereby the accuracy of the edited result is improved.

The editing program 7 constituted above is provided to an internet market for network sales.

As shown in FIG. 8, the editing program 7 is introduced on a web site (URL). A Menu screen including such items as “commodity introduction”, “download”, “support”, “user registration”, “frequent question” and the like for the editing program is displayed on the web site.

When an item of “commodity introduction” is selected, a summary of the editing program 7 comprising a top page of the editing program 7, an example of a display screen shown in FIGS. 4 and 5 and so on, is introduced.

When an item of “download” is selected, a procedure of downloading the editing program 7 is displayed. Using the downloaded editing program 7, a trial operation experience of editing any electronic document is allowed for a purchase applicant to perform free of charge for a certain number of times or a certain period of time. Thus, through performing said trial operation experience of editing electronic document for a certain number of times or a certain period of time, the purchase applicant concludes a sales contract, pays a predetermined charge, receives a purchase key (authentication number) and obtains an editing program 7 using the purchase key.

In addition to the sale of the editing program 7, an editing service of electronic documents can be provided. Namely, an edited result with high accuracy can be delivered to a client who wants to have his or her designated electronic document 1 edited to an improved accuracy, by correcting an incomplete read result by the symbol reading means 8 with a use of the editing program 7.

Moreover, in addition to the sale of the editing program 7, an edited electronic document using the editing program can be sold on the screen of the computer. For example, from many purchasers of the editing program, by purchasing their edited electronic documents and by compiling the purchased documents into a database, the database can be provided to an internet market for network sales.

### INDUSTRIAL APPLICABILITY

According to the editing program of the present invention, when any one of symbols among text information is designated, a corresponding symbol among image information is caused to be highlighted. Consequently, even if a large number of symbols are assigned to the image information or a large number of figures exist in the image information, the trouble of searching the symbol manually on the screen may be avoided, allowing a user to concentrate to understand the described contents. Furthermore, during the step of the editing operation, it is just enough to read a symbol among the image information and associate the symbol with a symbol among the text information. Thereby, the editing operation may be performed in a relatively short time, because it is unnecessary to recognize a character string among the text information as needed in the prior art.

Moreover, when the editing operation of one electronic document finishes and the edited electronic document is stored in a previously designated output field, an editing operation of the next electronic document automatically starts. This allows a large number of electronic documents to be edited rapidly and continuously.

Accordingly, the editing program of the present invention is applied not only to an editing of the patent information, but may be widely applicable to an editing of operation manuals, technical documents, research publication data, teaching materials, and the like. According to the editing program of the present invention, an incomplete read result of a symbol among the image information is corrected manually by the manual associating means, thereby increasing the accuracy of the editing.

In addition, according to the sales method of the editing program of the present invention, a sales contract and a delivery of the program are both performed on a computer screen, thereby enabling the sale to be rapid and economic.

Moreover, according to the sales method of the editing program of the present invention, an editing service of the electronic document using the editing program is added to the sale of the editing program itself, thereby it is expected to promote the sale of the editing program.

Further, according to the sales method of the editing program of the present invention, a sale of edited electronic documents is performed together with the sale of the editing program itself, thereby enabling to increase the added value of the electronic document.

### BRIEF DESCRIPTION OF THE DRAWINGS

FIG. 1 is a conceptual diagram showing a relationship of an electronic document and an editing program.

FIG. 2 is a conceptual diagram of the electronic document.

FIG. 3 is a conceptual diagram showing a symbol reading means of the editing program.

FIG. 4 is a schematic view showing a display screen of an edited electronic document.

FIG. 5 is a schematic view showing a display screen of an edited electronic document.

FIG. 6 is a flow chart illustrating an editing operation step according to the editing program.

FIG. 7 is a schematic view showing a display screen of a web site.

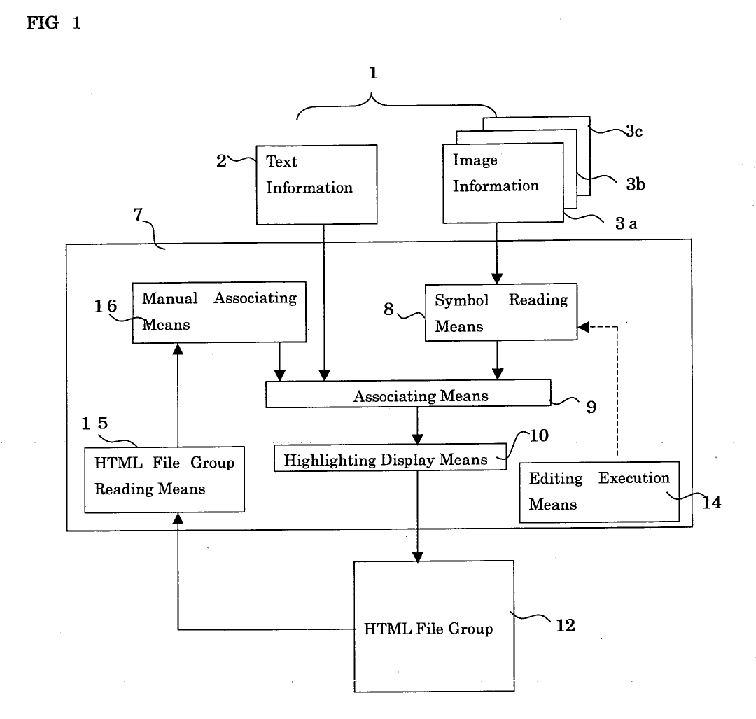

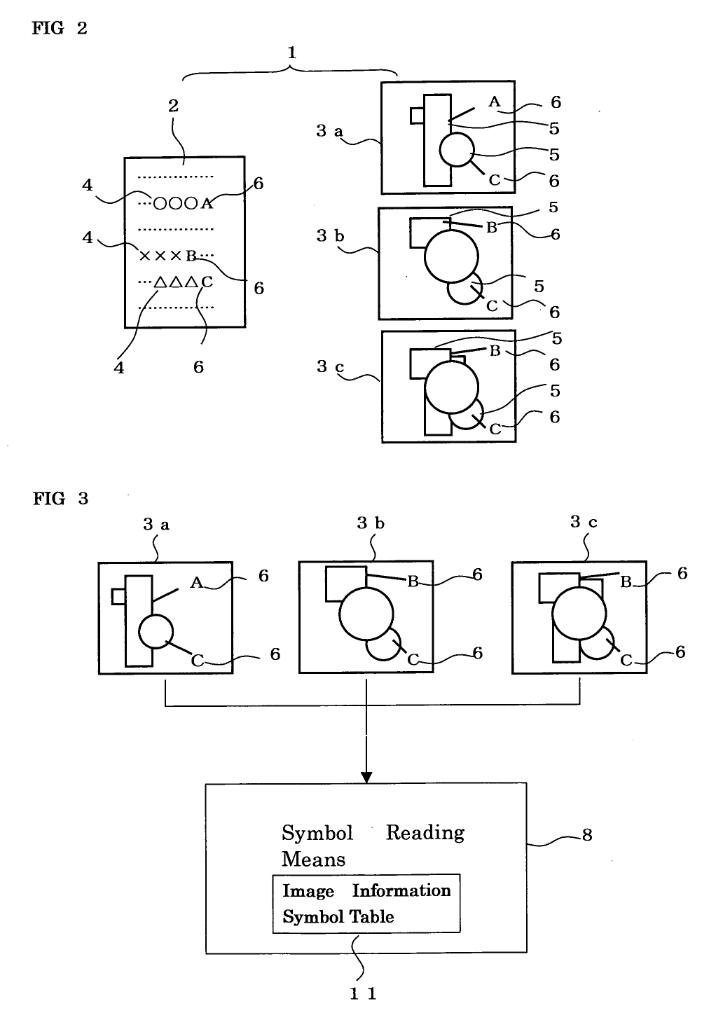

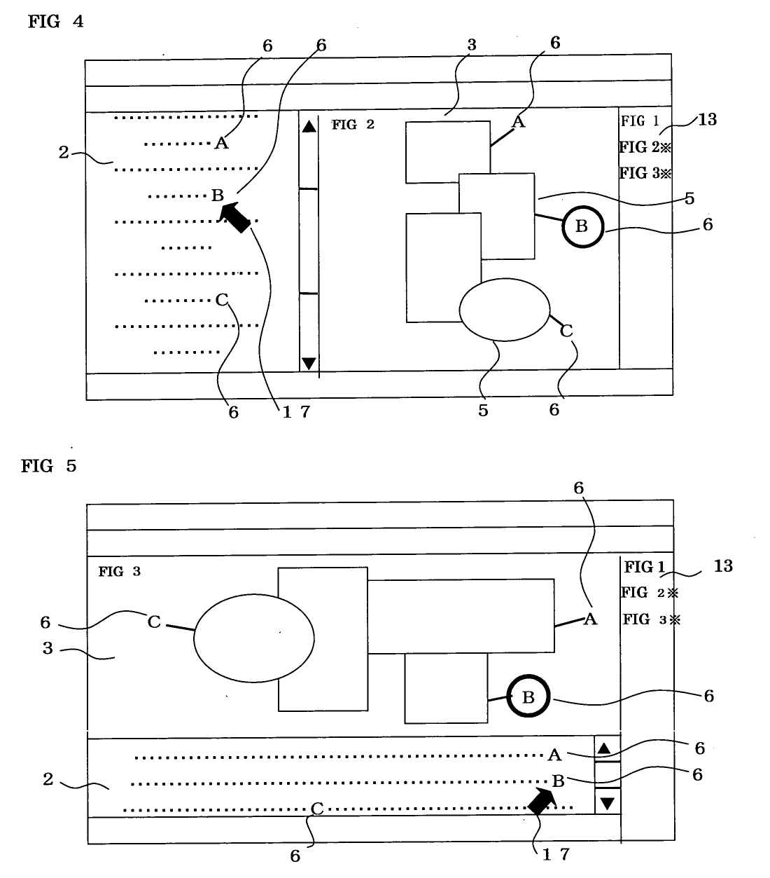

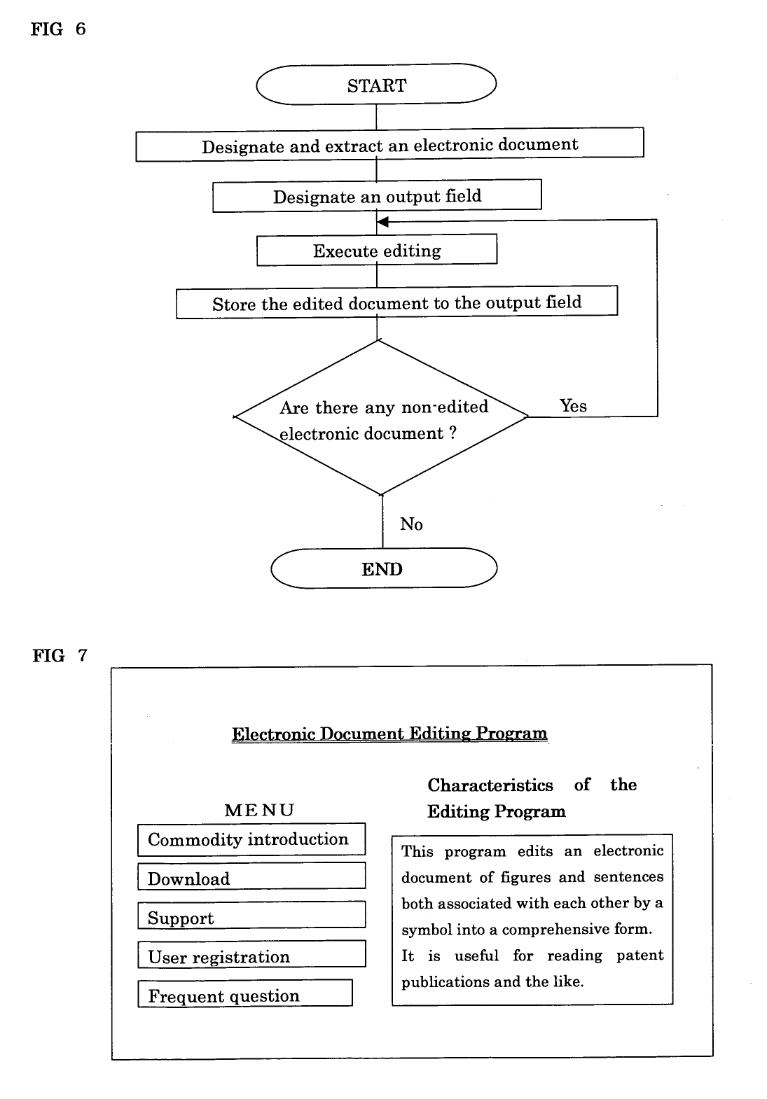

### DESCRIPTION OF REFERENCE NUMERALS

1: electronic document

2: text information

3a, 3b, 3c: image information

4: specific expression

5: specific part

6: symbol

7: editing program

8: symbol reading means

9: associating means

10: highlighting display means

16: manual associating means

1. An electronic document editing program for editing an electronic document that includes text information having a plurality of specific expressions and image information having a plurality of specific parts, and the electronic document of which the specific expression of the text information and the specific part of the image information are associated with each other through a common symbol, the electronic document editing program comprising:
a symbol reading means for reading symbols that exist in the image information and the location information thereof;
an associating means for associating a read result by the symbol reading means with the symbol that exists in the text information if a common symbol is allocated to both of them; and
a highlighting display means for highlighting a corresponding symbol in the image information on a computer screen based on the result of the associating means when any one of the symbols in the text information is designated, wherein,
the electronic document editing program is characterized in that said electronic document editing program sequentially extracts a plurality of electronic documents to be edited, and upon receiving an order to start the editing operation with a previously designated output field for each electronic document to be edited, edits one of the plurality of extracted electronic documents by the symbol reading means, the associating means, and the highlighting display means, stores the edited electronic document in the designated output field, and starts editing continuously a non-edited electronic document, if any, thereby enabling a plurality of electronic documents to be edited continuously.

2. The electronic document editing program as claimed in claim 1, further comprises a manual associating means for correcting an incomplete read results by the symbol reading means with a manual operation, and for reflecting the corrected result onto the associating means.

3. A sales method of an electronic document editing program for editing an electronic document that includes text information having a plurality of specific expressions and image information having a plurality of specific parts, the specific expression of the text information and the specific part of the image information are associated with each other through a common symbol; the electronic document editing program comprising:
a symbol reading means for reading symbols that exist in the image information and the location information thereof;
an associating means for associating a read result by the symbol reading means with the symbol that exists in the text information if a common symbol is allocated to both of them; and
a highlighting display means for highlighting a corresponding symbol in the image information on a computer screen based on the result of the associating means when any one of the symbols in the text information is designated, wherein,
the electronic document editing program sequentially extracts a plurality of electronic documents to be edited, and upon receiving an order to start the editing operation with a previously designated output field for each edited electronic document, edits one of the plurality of extracted electronic documents by the symbol reading means, the associating means, and the highlighting display means, stores the edited electronic document in the designated output field, and starts editing continuously a non-edited electronic document, if any, thereby enabling a plurality of electronic documents to be edited continuously; wherein
the sales method of the electronic document editing program is characterized in that a sales contract of the electronic document editing program and a delivery of the same are performed on a computer screen.

4. The sales method of an electronic document editing program as claimed in claim 3, further provides an editing service for editing an electronic document designated by a client using the editing program in addition to the sale of said editing program.

5. The sales method of an electronic document editing program as claimed in claim 3, further provides a sale of an edited electronic document using the editing program on a computer screen in addition to the sale of said editing program.
